(19) United States
(12) Patent Application Publication
(10) Pub. No.: US 2014/0013196 A1
(43) Pub. Date: Jan. 9, 2014

(54) ON-SCREEN ALERT DURING CONTENT PLAYBACK

(71) Applicant: Eric Foster WHITE, Littleton, CO (US)

(72) Inventor: Eric Foster WHITE, Littleton, CO (US)

(73) Assignee: Mobitude, LLC, a Delaware LLC, Littleton, CO (US)

(21) Appl. No.: 13/544,951

(22) Filed: Jul. 9, 2012

(51) Int. Cl. G06F 15/16; G06F 17/00

(52) U.S. Cl. 715/205; 709/204

(57) ABSTRACT

Embodiments of the disclosed herein relate to providing an on-screen alert during playback of content where the on-screen alert permits the user to connect to one of the characters (or an entity) shown or referred to in a web video or the program associated therewith. In addition, an authoring tool is disclosed herein for inserting an on-screen alert into a video (or other content) at a predetermined time reference, where the on-screen alert enables a first user to connect to a social networking system of a second user (or entity). A content management server or system may insert an on-screen alert into a video (or other content). The timing and selection of an alert may be tailored using user profile information which may be input by the user or inferred or ascertained based on a user's online activity, such as the user's selection of content to view on a site.

### BACKGROUND

Social networking has allowed people to connect with a variety of other individuals or entities (e.g., businesses or programs) by, for example, receiving messages, pictures, video from those to which a given individual is connected. Interactive television has also been a developed in which a viewer may, for example, participate in a survey. Users may be able to engage a cast member of a program by linking to the cast member using a social networking site or a mobile application on a user's smartphone. For example, many popular video sharing websites provide links to “follow,” “friend,” or “like” the video (or other content), creator of the content, or business associated with the content. Typically, these websites provide a link to a social networking system that may be constantly present on the viewer's screen regardless of the position of playback the content is in (e.g., the timecode of the video or what is transpiring in the video). A more targeted approach to social networking when viewing content is desirable, for example, to facilitate the effect of viewer interaction with the content (e.g., characters in a video) and to engage the user in a specific manner.

### BRIEF SUMMARY

According to an embodiment of the disclosed subject matter, profile information from a first user of a first social networking system may be received by, for example, a server. The first social networking system may be a social networking site or an Internet forum. The server, for example, may provide a video (or other content) for playback to a first user. An on-screen alert message may be provided to the first user at a predetermined time reference during playback of the video. The on-screen alert message may be an invitation to connect with a second user of a second social networking system. The first and second user may belong to the same social networking system (i.e., the first and second social networking systems may be the same). A similar process may be employed for audio or multimedia content.

Invitations to connect to the second user may take various forms. For example, the invitation may be to follow or to friend the second user on a social networking site. The user profile of the first user may be associated with the second user. For example, if a first user connects to the social networking system of the second user, the first user's profile may be presented or visible to other users who are also connected to the second user. The other users may be said to be in an “extended” network of the first user (and vice versa). The first user may thus receive information related to the second user. In another example of an invitation to connect to the second user may be to like an entity. The first user may receive an invitation to join the social networking system of the second user.

Information in a user profile may include, for example and without limitation, a username, a birthdate, an image such as a profile image, a mobile phone number, an email address, a social network user identifier, a gender, a video content, an audio content, a location, and a country. In addition, the user profile may indicate whether or not the user is interested in receiving on-screen alerts or connecting to the social networking system of other users, cast members of a video, or entities associated with a video. For example, a user may elect to participate in certain offerings provided by a particular multimedia content (e.g., connecting with cast members but not a program series or business). User profile information may also include information about user activities. For example, it may include information that is aggregated based upon the first user's activity on the website on which the video (or other content) is located (i.e., including the parent site and any related pages or sites). For example, a user viewing videos of a particular cast member or other information about the cast member may be targeted to have an invitation to join that cast member's social networking system.

A predetermined time reference in the video may correspond to an occurrence of an event depicted in the video. For example, an event depicted in the video may be used as the basis of the time reference (e.g., the entry of a particular cast member or a cast member indicating transmission of a text message in the video). The event depicted in the video may also be, for example, the appearance of an advertisement. A time reference may also be a timecode. For example, in a video with a duration of one minute, a timecode reference may indicate that at 30 seconds, the on-screen alert is to be provided to the first user. Another example of a timecode is an SMPTE timecode.

The on-screen alert may include an advertisement in addition to the invitation to connect to the social networking system of the second user. The advertisement may be based on the user profile information. The event depicted in the video or other content (e.g., time reference) may also be an appearance of an advertisement. The on-screen alert may include a hyperlink. The first user may select the hyperlink in the on-screen alert (e.g., by clicking the link). The selection of the hyperlink may automatically cause the first user to be added to the social networking system of the second user. The first user may be targeted to receive the on-screen alert based upon information contained in the user profile.

The on-screen alert, video, and the time reference may be stored in one or more databases, for example. According to an implementation of the disclosed subject matter, the on-screen alert may be inserted into the video at the specified time reference. For example, a database may store a plurality of each of various forms of content or data including video (or other content such as audio or multimedia), time references, and on-screen alerts. In some instances, time references may be associated with the on-screen alerts. That is, a single on-screen alert for a first cast member may have various time references depending on the content (e.g., video) that it is to be associated with. A database may provide (e.g., stream or transmit to a network or server) the on-screen alert determined to be provided to a user based on the video, time reference, and user profile information. In an embodiment, an authoring tool is described for inserting on-screen alerts, which contain an invitation to join a social network, into content such as video.

In an embodiment a system contains a database for storing profile information of a first user of a first social networking system. A processor is connected to the database and is configured to provide a video for playback to the first user. The processor may be configured to provide an on-screen alert message to the first user at a predetermined time reference during playback of the video. The on-screen alert message comprises an invitation to connect with a second user of a second social networking system. As above, the first and second social networking systems are the same social networking system.

Additional features, advantages, and embodiments of the disclosed subject matter may be set forth or apparent from consideration of the following detailed description, drawings, and claims. Moreover, it is to be understood that both the foregoing summary and the following detailed description are exemplary and are intended to provide further explanation without limiting the scope of the claims.

### BRIEF DESCRIPTION OF THE DRAWINGS

The accompanying drawings, which are included to provide a further understanding of the disclosed subject matter, are incorporated in and constitute a part of this specification. The drawings also illustrate embodiments of the disclosed subject matter and together with the detailed description serve to explain the principles of embodiments of the disclosed subject matter. No attempt is made to show structural details in more detail than may be necessary for a fundamental understanding of the disclosed subject matter and various ways in which it may be practiced.

FIG. 1 shows a computer according to an embodiment of the disclosed subject matter.

FIG. 2 shows a network configuration according to an embodiment of the disclosed subject matter.

FIG. 3 shows an example information flow for providing an on-screen alert during playback of content according to an embodiment of the disclosed subject matter.

FIG. 4 is an example configuration of a content management server and the associated databases.

FIG. 5 shows a video playback screen with an on-screen alert that appears between timecodes 2:00 and 2:30.

FIG. 6 is an example process flow for the decision to connect to a character's social networking system.

### DETAILED DESCRIPTION

Briefly, some embodiments of the disclosed subject matter relate to providing an on-screen alert during playback of content where the on-screen alert permits the user to connect to one of the characters (e.g., cast members) that appears in the content or the program associated therewith. In some instances, the user and the character may already be members of, for example, the same social networking site. Using an authoring tool disclosed herein, an on-screen alert may be inserted into a video (or other content). The timing and selection of an alert may utilize user profile information which may be entered by the user or inferred or ascertained based on a user's online activity (e.g., the user's selection of content to view on a site). The foregoing description typically refers to playback of a video; however, embodiments disclosed herein are not so limited. Other forms of content, such as multimedia or audio content, may also be employed in a manner similar to that of video according to present disclosure.

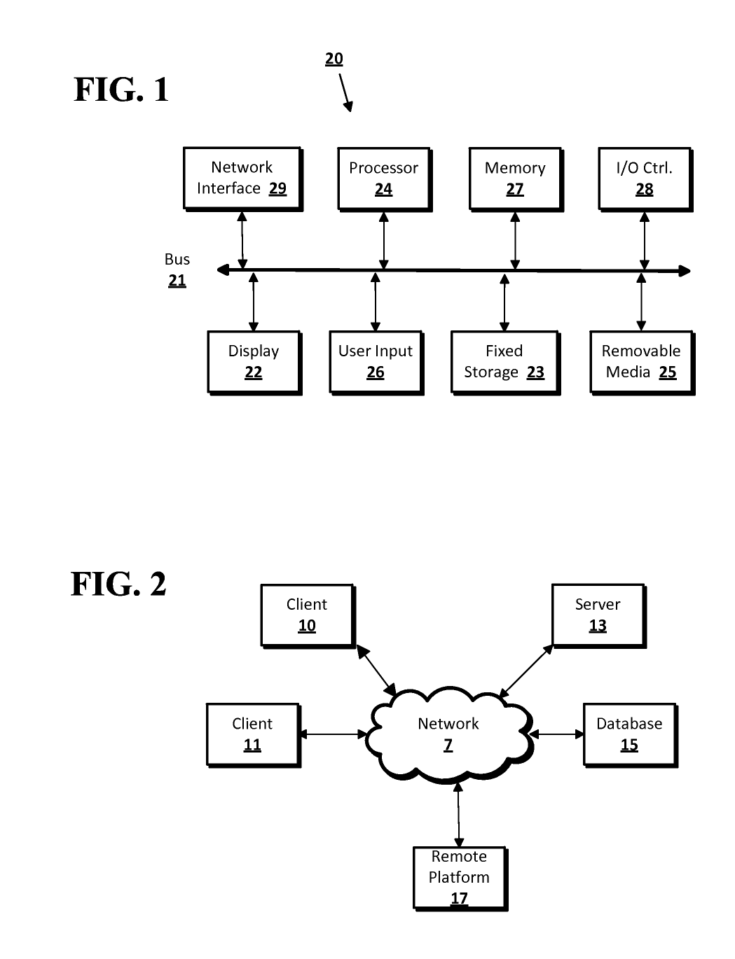

Embodiments of the presently disclosed subject matter may be implemented in and used with a variety of component and network architectures. FIG. 1 is an example computer 20 suitable for implementing embodiments of the presently disclosed subject matter. The computer 20 includes a bus 21 which interconnects major components of the computer 20, such as a central processor 24, a memory 27 (typically RAM, but which may also include ROM, flash RAM, or the like), an input/output controller 28, a user display 22, such as a display screen via a display adapter, a user input interface 26, which may include one or more controllers and associated user input devices such as a keyboard, mouse, and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 allows data communication between the central processor 24 and the memory 27, which may include read-only memory (ROM) or flash memory (neither shown), and random access memory (RAM) (not shown), as previously noted. The RAM is generally the main memory into which the operating system and application programs are loaded. The ROM or flash memory can contain, among other code, the Basic Input-Output system (BIOS) which controls basic hardware operation such as the interaction with peripheral components. Applications resident with the computer 20 are generally stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may allow the computer to communicate with other computers via one or more local, wide-area, or other networks, as shown in FIG. 2.

Many other devices or components (not shown) may be connected in a similar manner (e.g., document scanners, digital cameras and so on). Conversely, all of the components shown in FIG. 1 need not be present to practice the present disclosure. The components can be interconnected in different ways from that shown. The operation of a computer such as that shown in FIG. 1 is readily known in the art and is not discussed in detail in this application. Code to implement the present disclosure can be stored in computer-readable storage media such as one or more of the memory 27, fixed storage 23, removable media 25, or on a remote storage location.

FIG. 2 shows an example network arrangement according to an embodiment of the disclosed subject matter. One or more clients 10, 11, such as local computers, smart phones, tablet computing devices, and the like may connect to other devices via one or more networks 7. The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15.

More generally, various embodiments of the presently disclosed subject matter may include or be embodied in the form of computer-implemented processes and apparatuses for practicing those processes. Embodiments also may be embodied in the form of a computer program product having computer program code containing instructions embodied in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing embodiments of the disclosed subject matter. Embodiments also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing embodiments of the disclosed subject matter. When implemented on a general-purpose microprocessor, the computer program code segments configure the microprocessor to create specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Embodiments may be implemented using hardware that may include a processor, such as a general purpose microprocessor and/or an Application Specific Integrated Circuit (ASIC) that embodies all or part of the techniques according to embodiments of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to embodiments of the disclosed subject matter.

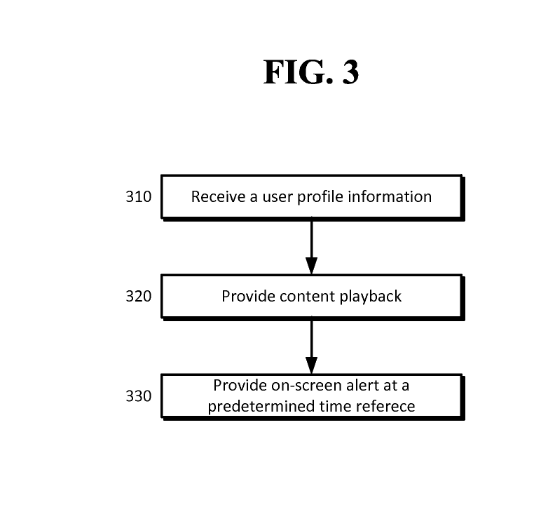

In an embodiment shown in FIG. 3, profile information from a first user of a first social networking system may be received at 310. For example, a user may subscribe or create a user name and password to access a website. The website may contain content with which the user would like to interact and, in order to do so, the user may be required to subscribe to the website (e.g., creating an account or registering with the website). In addition to a username and password, user profile information may also include, for example, a birthdate, an image such as a profile image, a mobile phone number, an email address, a social network user identifier, a gender, a video content, an audio content, a location, and a country. Other information may also be entered into a user profile and constitute profile information. For example, a user may indicate a desired level of participation in social networking with content provided on the website, such as whether or not the user would be interested in receiving offers to connect to the social networking system of one of the cast members of a video (e.g., another user), or an entity associated with a video or other content (e.g., a production company, producer, or a program series to which the video belongs). A user may elect to participate in certain offerings provided by a particular multimedia content (e.g., connecting with cast members but not a program series or business). User profile information may indicate whether or not the user is interested in receiving on-screen alerts.

User profile information may also include items not physically entered by a user or system administrator; rather, it may include information that is collected based upon the first user's activity on a website on which the content (e.g., video) is located (i.e., including the parent site and any related pages or sites). For example, a user viewing videos of a particular cast member or other information about the cast member may be targeted to have an invitation to connect to that cast member's social networking system relative to another user who has never viewed content containing the same cast member. The user profile information may be maintained, for example, in a database 15 that is connected to a server 13 and the user's computer (e.g., client 10) via a network 7 as shown in FIG. 2.

A social networking system may include a social networking site and its associated content (including the network of users or an internet forum). A social networking site may permit users, once registered, to connect with other acquaintances or friends. Typically, a user is provided recommendations of individuals and/or other entities with whom the user may like to associate (or know) based on a user profile or people with whom the user has already associate with on the website. A user may request, reject, accept, or ignore a friend invitation with other users of the social networking site. In some social networking systems, a user may simply follow the web postings of another user (e.g., text-based messages posted by the other user). Social networking sites typically use terms such as “friend,” “like,” or “follow” to describe a user's association with another user, content, or entity. For example, a user may elect to follow a particular celebrity or a restaurant. In doing so, the user may, for example, receive offers (e.g., advertisements or promotions), images or other like content, or be able to view or receive the postings from the celebrity or restaurant.

Returning to FIG. 3, once a user has entered the website, playback of video (or similar content such as multimedia or audio) may be provided at 320. For example, a user may connect to a website over a network 7. The website may be provided by a content management server (“CMS”) 420. The CMS 420 may have a hardware configuration as shown, for example, in FIG. 1. It may receive a request to initiate playback of a video.

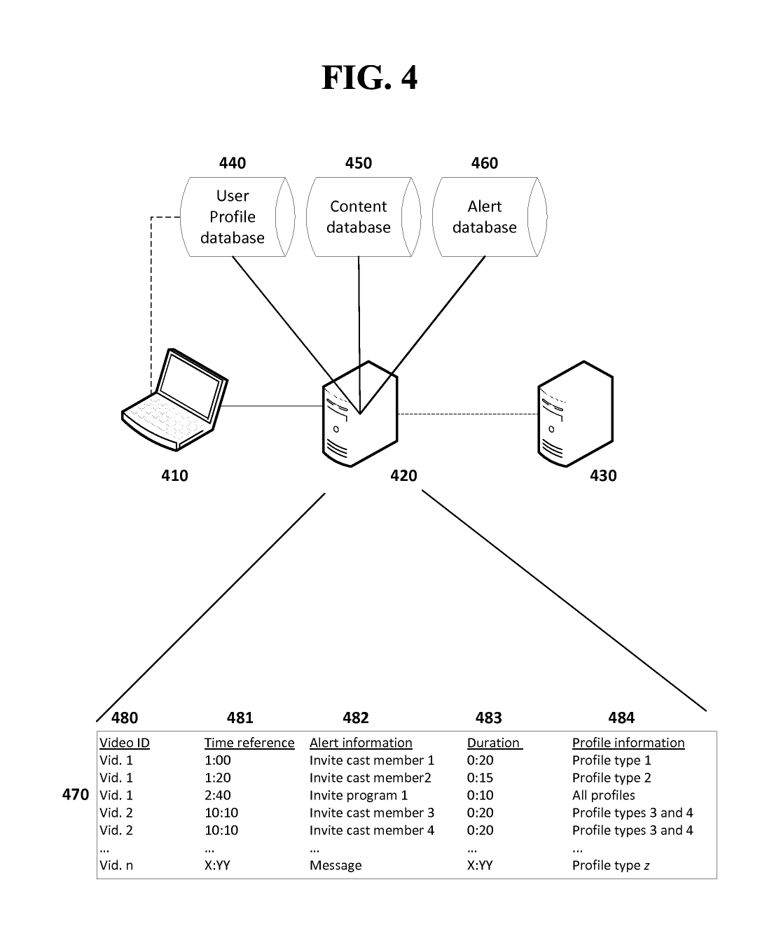

An example configuration of a content management server, associated databases, and a user computer is shown in FIG. 4. The CMS 420 may be connected to a series of databases that may be remotely or locally connected to the databases. Although the configuration shown in FIG. 4 displays three discrete databases, another configuration may have one computer readable storage medium (e.g., fixed storage 23) that stores information contained in the three discrete databases shown therein. Similarly, the CMS may include the three databases as part of its fixed storage or otherwise locally store the content and information contained in the databases.

As shown in FIG. 4, the CMS 420 can be connected to three databases: a user profile database 440, a content database 450, and an alert database 460. The user profile information database 440 may include information entered by, for example a user, or information that is based upon the online activity of the user (including information gathered from, for example, a machine learning algorithm based on user's online behavior). The content database 450 may include episodes of an online program (e.g., video) or other similar content (e.g., multimedia or audio). The alert database 460 may include, for example time reference information, duration information and the alert that is to be displayed on the user's computing device 410. The time reference information and duration information may also be stored in a separate database.

The CMS 420 may be connected to a user computing device 410. The user computing device 410 may include a laptop, desktop PC, mobile phone, tablet, a web-enabled device, or the like. In another configuration, the CMS 420 sends content or data over a network 7 to another server 13 or cloud-based service which may be in contact with the user's computing device 410. The CMS 420 may receive a request for playback of a video from the user computing device 410. Optionally, the CMS 420 may also be connected to a social network system at 430 to allow automatic authentication, verification, or both authentication and verification of the first user with respect to joining the second user's social networking system. The CMS 420 may collect information from the three databases and organize it in the configuration shown at 470 which itself may be stored on the computer readable medium of the CMS 420 or stored in a separate database that may be accessed by the CMS 420. In another configuration, the CMS 420 can be used only to access the databases while a separate server 13 performs the step of aggregating the information into the accessible format shown at 470.

The CMS 420 (or other server or database used for assembling the data shown at 470) may maintain a database of the Video ID 480, time reference 481, alert information 482, duration of the alert 483, and profile information 484. Some configurations may use more or less data than is shown in 470 (e.g., only a time reference and alert information may be provided by the database or used for playback of content). Additional information may be included at 470 such as the location or position of the alert on the user's computing device 410.

The time reference 481 may indicate at what point during playback the alert information 482 is to be shown on the screen of the user's computing device 410. The time reference 481 may be considered predetermined because it is established in advance at what point the alert 482 is to be shown during playback of content (e.g., video). The alert information 482, for example, may be an offer to connect to the social network of a second user (e.g., a character or cast member in the video that is being played). The duration 483 of time that the alert information 482 is to be provided on screen may also be provided. For example, if a user does not take any action, the duration 483 may be the maximum length of time that an alert 482 may be displayed. Profile information 484 represents a grouping of a given user into a particular type based on information contained in the user profile database 440.

In some instances, an alert 482 may be targeted to users belonging to a particular profile type (e.g., females aged 35-45). A content (e.g., video) may have more than one alert 482 provided during playback. In some configurations, all alerts for a given profile are inserted into the video but not triggered (e.g., transmitted or inserted into the video content) during playback unless one or more conditions are satisfied (e.g., profile type). In other instances, the CMS 420 for example, provides only those alerts for which the user has a matching profile information 484. In another configuration, an alert 482 may be provided by the CMS 420 on the fly, that is, the CMS 420 may monitor playback of the content and when the playback reaches a predetermined time reference 481, the CMS 420 may provide the alert information 482. The alert information 482 may be provided from the alert database 460.

The CMS 420 (or server 13 or the like) may perform a filtering function prior to or during playback of content. For example, it may filter based on profile information 484, for example, the user's age, gender, and stated interests. Filtering may also be performed on the type of alert. For example, some alerts may contain advertisements. The mechanism employed to connect the first user to the social networking system of the second user may also vary. For example, one mechanism may employ a hyperlink or selectable text while another may require additional steps such as, upon agreeing to connect to the social networking system of the second user, the first user may be required to provide an email address to which the invitation may be formally accepted, authenticated, or verified. The type of alert may also vary based on the type of social networking system or site that the invitation is for. As described above, some social networking sites offer the ability to receive text-based information or to “follow” another user. Other social networking sites allow exchange of more content (e.g., pictures, videos, web postings, etc.). Other types of filtering performed by the CMS 420 or the like may be based on a recommendation engine or machine learning algorithm. For example, based on the user's past activity on the website, the user may be provided a filtered content or on-screen alert.

The time reference 481 shown in FIG. 4 is based on a timecode, that is, a specified time for display of the on-screen alert information 482. However, a time reference 481 may also be based on the occurrence of an event depicted in the video (or other content). For example, the appearance of a particular cast member in a video may trigger an on-screen alert to be provided by the CMS 420. In another example, the appearance of a particular product (e.g., advertisement) may trigger an alert to follow the producer of that product. Multiple on-screen alerts may also be provided by the CMS 420 during playback of content and more than one on-screen alert may appear on the user's screen simultaneously.

The configuration shown in FIG. 4 may also be utilized as part of a web content authoring system for inserting into content on-screen alerts that contains an invitation to connect to a social networking system.. For example, the insertion of alerts 482 based on profile information 484 and video ID 480 based on the data provided by the user profile database 440, content database 450, and alert database 460 may be performed by the CMS 420 (or similar server 13). The modified video (or other content such as multimedia or audio) may be stored to a computer readable medium. The stored modified video may then be provided, upon request, to a computing device (e.g., server 13, user computing device 410, or the like).

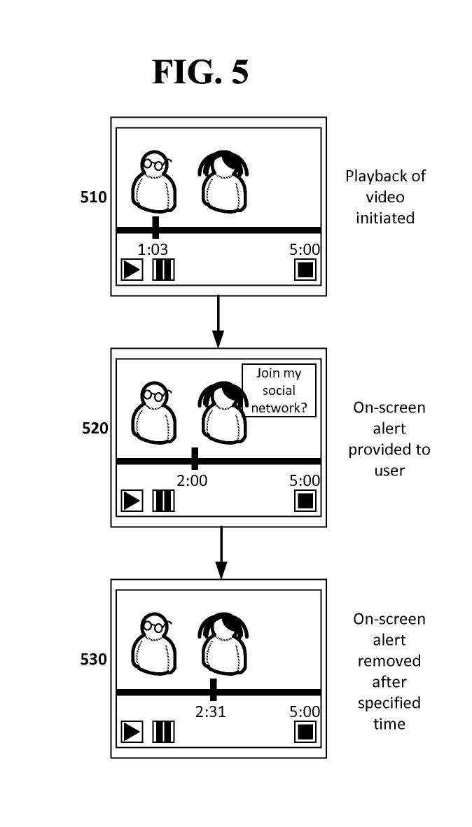

Returning to FIG. 3, an on-screen alert message may be provided to the first user at a predetermined time reference during playback of the video (or other content) at 330. The on-screen alert message may be an invitation to connect with a second user of a second social networking system. The first and second user may belong to the same social networking system in which case the first and second social networking systems may be the same. FIG. 5 shows an example of video playback and an on-screen alert. At 510, playback of a video may be initiated. As described previously, a video (or other content) may be selected from among several videos on a website. The CMS 420 may provide the video to the user computing device 410. Upon reaching a predetermined time reference (e.g., 2:00 minutes as shown in FIG. 5 at 520), an on-screen alert is provided to the user to join the social networking system of one of the individuals in the video. As described earlier, the on-screen alert may vary, for example, in type, location, message, or action (e.g., what happens when activated). The on-screen alert may include instructions on how to join the second user's (or entity's) social networking system. It may also include a hyperlink or the text itself may be a hyperlink. The on-screen alert may also include an advertisement which may be targeted to the user based on user profile information. The on-screen alert may have a specified duration. In the example shown at 530, the duration of the alert does not exceed 30 seconds. At timecode 2:31 of the video, the on-screen alert is removed from the screen of the computing device. The on-screen alert may appear elsewhere on the computer screen besides the video viewing pane (e.g., below the video pane or another location on the web page).

Invitations to connect to the second user may take various forms. For example, the invitation may be to follow or to friend the second user on a social networking site. The user profile of the first user may be associated with the second user. . For example, if a first user connects to the social networking system of the second user, the first user's profile may be presented or visible to other users who are also connected to the second user. The other users may be said to be in an “extended” network of the first user (and vice versa). The first user may thus receive information related to the second user. For example, because the first user is connected to the second user, the first user may receive pictures, have access to the second user's web postings, or receive other forms of electronic communication and content from the second user. In another example of an invitation to connect to the second user may be to like an entity. For example, the first user may be presented with an on-screen alert to join the social networking system of a particular show. A show may have two or more videos associated with it that may represent a series (and similar to a TV show). The first user may receive an invitation to join the social networking system of the second user.

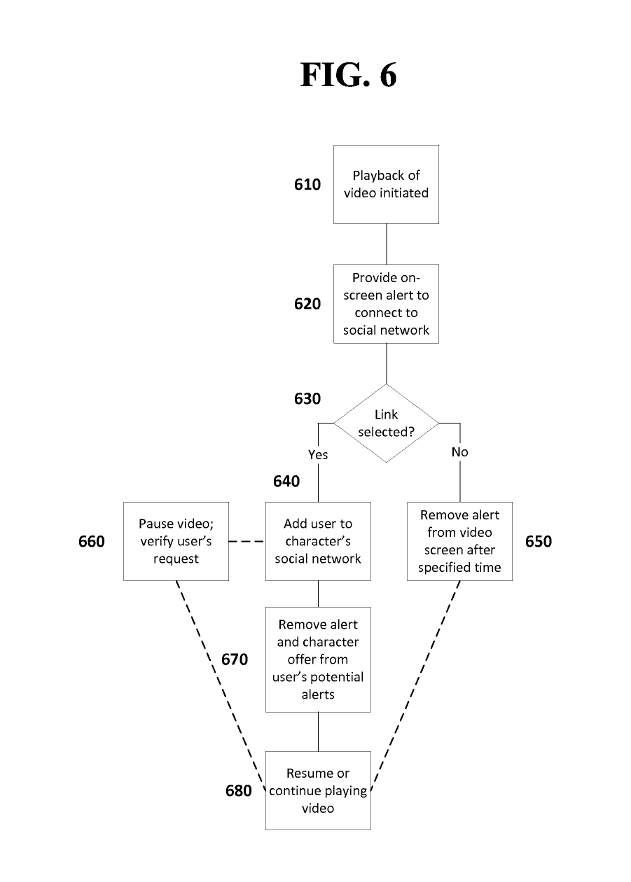

FIG. 6 shows an example process flow for joining a second user's social network. At 610, playback of video (or other content) is initiated as described above. At a predetermined time reference, an on-screen alert may be provided and it may be based on user profile information at 620. The on-screen alert may include a hypertext link. The first user may select (i.e., click on) the link or not at 630. If the user takes no action, the alert may be removed from the user's screen after passage of a specified time at 650. Similarly, the user may elect to close the window containing the on-screen alert. In a configuration, the appearance of the on-screen alert may cause the video (or other content) to be automatically paused while in another configuration the alert may have no effect on the playback of content. For example, the alert may open a new web browser page or it may appear in a new window which does not obscure content playback.

At 640, if the link is selected, the user may be added to, for example, a character's social network system. If the CMS 420 is connected to a social networking system, it may have the ability to verify or authenticate the user's addition to the character's social networking system automatically. In another configuration, the selection of the link may require the user to verify that she would like to connect to the character's social network at 660. As described above, opting to connect to the second character's social network may cause playback of the content to be suspended until the user takes a further action (e.g., verifies the connection or removes the alert). Upon the subsequent action, the video may resume or continue playing at 680. Connecting to the character's social networking system may also remove similar alerts on other content the user may view on the web site or not provide the invitation for the content to avoid inviting the user to connect to the social networking system of a character (entity or the like) to which the user is already connected at 670.

In another embodiment a system is disclosed. The system contains a database for storing profile information of a first user of a first social networking system. A processor is connected to the database and is configured to provide a video for playback to the first user. The processor may be configured to provide an on-screen alert message to the first user at a predetermined time reference during playback of the video (or other content). The on-screen alert message comprises an invitation to connect with a second user (or entity) of a second social networking system. As above, the first and second social networking systems are the same social networking system.

The foregoing description, for purpose of explanation, has been described with reference to specific embodiments. However, the illustrative discussions above are not intended to be exhaustive or to limit embodiments of the disclosed subject matter to the precise forms disclosed. Many modifications and variations are possible in view of the above teachings. The embodiments were chosen and described in order to explain the principles of embodiments of the disclosed subject matter and their practical applications, to thereby enable others skilled in the art to utilize those embodiments as well as various embodiments with various modifications as may be suited to the particular use contemplated.

1. A computer-implemented method comprising:
receiving profile information from a first user of a first social networking system;
providing a video for playback to the first user, and
providing an on-screen alert message to the first user at a predetermined time reference during playback of the video, wherein the on-screen alert message comprises an invitation to connect with a second user of a second social networking system.

2. The method of claim 1, wherein the first and second social networking systems are the same social networking system.

3. The method of claim 1, wherein the invitation to connect is selected from the group consisting of: following the second user on a social networking site, friending the second user on a social networking site, associating the user profile of the first user with the second user, receiving information related to the second user, joining the second user's social networking system, and liking an entity.

4. The method of claim 1, wherein the profile information is selected from the group consisting of: a username, a birthdate, a profile image, a mobile phone number, an email address, a social network user identifier, a gender, an image, a video content, an audio content, a location, and a country.

5. The method of claim 1, wherein the predetermined time reference corresponds to an occurrence of an event depicted in the video.

6. The method of claim 5, wherein the event depicted in the video includes an appearance of the second user in the video.

7. The method of claim 5, wherein the event depicted in the video is an appearance of an advertisement.

8. The method of claim 1, wherein the time reference is a timecode.

9. The method of claim 1, wherein the on-screen alert message contains a hyperlink.

10. The method of claim 9 further comprising:
receiving selection of the hyperlink; and
automatically causing the first user to added to the social networking system of the second user.

11. The method of claim 1, further comprising targeting the first user to receive the alert based upon the profile information.

12. The method of claim 1, further comprising:
receiving an on-screen alert and the time reference; and
inserting the on-screen alert into the video at the predetermined time reference.

13. A system comprising:
a database for storing profile information from a first user of a first social networking system;
a processor connected to the database, the processor configured to:
provide a video for playback to the first user, and
provide an on-screen alert message to the first user at a predetermined time reference during playback of the video, wherein the on-screen alert message comprises an invitation to connect with a second user of a second social networking system.

14. The system of claim 13, wherein the first and second social networking systems are the same social networking system.

15. The system of claim 13, wherein the invitation to connect is selected from the group consisting of: following the second user on a social networking site, friending the second user on a social networking site, associating the user profile of the first user with the second user, receiving information related to the second user, joining the second user's social networking system, and liking an entity.

16. The system of claim 13, wherein the profile information is selected from the group consisting of: a username, a birthdate, a profile image, a mobile phone number, an email address, a social network user identifier, a gender, an image, a video content, an audio content, a location, and a country.

17. The system of claim 13, wherein the predetermined time reference corresponds to an occurrence of an event depicted in the video.

18. The system of claim 17, wherein the event depicted in the video includes an appearance of the second user in the video.

19. The system of claim 17, wherein the event depicted in the video is an appearance of an advertisement.

20. The system of claim 13, wherein the time reference is a timecode.

21. The system of claim 13, wherein the on-screen alert message contains a hyperlink.

22. The system of claim 21, the processor further configured to:
receiving selection of the hyperlink; and
automatically causing the first user to added to the social networking system of the second user.

23. The system of claim 13, the processor further configured to target the first user to receive the alert based upon the profile information.

24. The system of claim 13, further comprising the processor configured to:
receive an on-screen alert and the time reference; and
insert the on-screen alert into the video at the predetermined time reference.
